(19) United States
(12) Patent Application Publication
(10) Pub. No.: US 2021/0065292 A1
(43) Pub. Date: Mar. 4, 2021

(54) ENHANCED EDUCATION AND COMPETITIVE REWARD TOOLS FOR RESOURCE ACCOUNTS

(71) Applicant: BANK OF AMERICA CORPORATION, Charlotte, NC (US)

(72) Inventors: Christina Ann Lillie, Ann Arbor, MI (US); Charles Jason Burrell, Middleburg, FL (US); Sara Suzanne Carr, Fort Mill, SC (US); Jane Elizabeth Cook, Charlotte, NC (US); Justin Riley duPont, Charlotte, NC (US); Kajal Gupta, Charlotte, NC (US); Bradley Ryan Holland, Huntersville, NC (US); Robert Nyeland Huggins, Charlotte, NC (US); Kashif M. Siddiqui, Livingston, NJ (US)

(73) Assignee: BANK OF AMERICA CORPORATION, Charlotte, NC (US)

(21) Appl. No.: 17/000,669

(22) Filed: Aug. 24, 2020

Related U.S. Application Data
(60) Provisional application No. 62/894,082, filed on Aug. 30, 2019.

(51) Int. Cl. G06Q 40/02; G06Q 10/10; G09B 19/18; G06F 3/0484

(52) U.S. Cl. CPC G06Q 40/02; G06F 3/04842; G09B 19/18; G06Q 10/10

(57) ABSTRACT

The present disclosure embraces a system, methods and computer program products for the intelligent on-boarding, support, education of non-conventional resource account users. In particular, the present disclosure includes tools for aggregation and intelligent data sharing between multiple users and associated resource accounts in order to generate a comparison between resource accounts and identify and incentivize potential earning opportunities. The competitive comparison may be continuously updated as earning opportunities are completed by the various users, and educational modules are provided via a resource account interface related to various topics of resource management responsibility for guided and reinforced learning.

### CROSS REFERENCE AND PRIORITY CLAIM UNDER 35 U.S.C. § 119

The present Application for a Patent claims priority to U.S. Provisional Patent Application Ser. No. 62/894,082 entitled “NON-CONVENTIONAL RESOURCE DISTRIBUTION MANAGEMENT SYSTEM,” filed on Aug. 30, 2019 and assigned to the assignee hereof and hereby expressly incorporated by reference herein.

### FIELD

The present invention generally relates to systems and tools for the guided creation, management, and utilization of supervised resource accounts.

### BACKGROUND

There is a need for an efficient and intelligent way to educate and introduce non-conventional resource account users to management of resource accounts in order to provide increased access to resources and promote best practices for resource planning, investing, and spending.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The present disclosure is directed to a system for the intelligent on-boarding, supervision, and support of non-conventional resource account users. In particular, the invention may provide an interactive and customizable interface and platform that is designed to gradually introduce new resource account users and provide existing resource account users with controls, educational tools, motivations, and rewards associated with supervised resource account users

Embodiments of the invention relate to systems, computer implemented methods, and computer program products for intelligent onboarding of non-conventional user resource accounts, generally comprising the steps of receiving, from a user device, a request to access the resource account management platform; displaying to the user, via a graphical interface of the resource account management platform, a resource account summary and resource account management selections, wherein the resource account management selections comprise an option to onboard a second user; receiving a selection to onboard the second user to the resource account management platform; onboarding the second user by automatically creating a resource account for the second user and linking the resource account for the second user with a resource account of the user by authorizing resource transfers from the resource account of the user and the resource account of the second user; and automatically linking the resource account for the second user with one or more related user resource accounts.

In some embodiments, the one or more related user resource accounts further comprise existing resource accounts on the resource account management platform belonging to relatives, friends, or peers of the second user.

In some embodiments, the system further comprises completing a resource transfer to the resource account of the second user; identifying an originating account of the resource transfer as one of the one or more related user resource accounts; determining a recommendation for allocation of the resource transfer; and transmitting the recommendation for allocation of the resource transfer to the second user via the graphical user interface.

In some embodiments, the system further comprises generating a template message to the owner of the originating account from the second user, wherein the template message includes a reference to the recommendation for allocation of the resource transfer.

In some embodiments, the system further comprises receiving a request from the second user to initiate a borrow request, wherein the borrow request comprises borrowing a resource amount from the user; transmit the borrow request to the user via the graphical user interface of the resource account management platform; provide options via the graphical user interface for the user to set negotiation terms for the borrow request, wherein the negotiation terms include a payback period, an optional interest rate, or required task; and transmit the negotiation terms to the second user via the graphical user interface.

In some embodiments, the system further comprises receiving a request from the second user to initiate a collaborative transaction, wherein the collaborative transaction comprises combining resources from the resource account of the user and the resource account of the second user; transmitting the collaborative transaction request to the user via the graphical user interface of the resource account management platform; providing options via the graphical user interface for the user to accept the collaborative transaction request; and executing the collaborative transaction using resources from the resource account of the user and the resource account of the second user.

In some embodiments, the system further comprises transmitting a follow-up message to the user after the collaborative transaction, wherein the follow-up message comprises educational talking point recommendations for discussion with the second user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an operating environment for the resource distribution account management platform, in accordance with one embodiment of the present disclosure;

FIG. 2 provides a block diagram illustrating a user device system, in accordance with an embodiment of the invention;

FIG. 3 illustrates a process flow for a resource transfer acceptance and response process, in accordance with one embodiment of the present disclosure;

FIG. 4 illustrates a process flow for initiation and management of a borrowed resource transfer between user resource accounts, in accordance with one embodiment of the present disclosure; and

FIG. 5 illustrates a process flow for initiation execution of a collaborative resource transaction, in accordance with one embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” as used herein may refer to an individual or an organization that owns and/or operates an online system of networked computing devices, systems, and/or peripheral devices on which the system described herein is implemented. The entity may be a business organization, a non-profit organization, a government organization, or the like, which may routinely use various types of applications within its enterprise environment to accomplish its organizational objectives.

“Entity system” as used herein may refer to the computing systems, devices, software, applications, communications hardware, and/or other resources used by the entity to perform the functions as described herein. Accordingly, the entity system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

“Computing system” or “computing device” as used herein may refer to a networked computing device within the entity system. The computing system may include a processor, a non-transitory storage medium, a communications device, and a display. The computing system may be configured to support user logins and inputs from any combination of similar or disparate devices. Accordingly, the computing system may be a portable electronic device such as a smartphone, tablet, single board computer, smart device, or laptop. In other embodiments, the computing system may be a stationary unit such as a personal desktop computer, networked terminal, IoT device, or the like.

“User” as used herein may refer to an individual who may interact with the entity system to access the functions therein. Accordingly, the user may be an agent, employee, associate, contractor, or other authorized party who may access, use, administrate, maintain, and/or manage the computing systems within the entity system. In other embodiments, the user may be a client or customer of the entity.

Accordingly, as used herein the term “user device” or “mobile device” may refer to mobile phones, personal computing devices, tablet computers, wearable devices, desktop computers, laptop computers, IoT devices, smart devices (e.g., smart watches), and/or other types of computing systems or devices and/or any electronic device capable of receiving and/or storing data therein.

“Resource” as used herein may refer to an object under the ownership of a user which is stored or maintained by the entity on the user's behalf. The resource may be intangible or tangible objects such as data files, documents, biographical data, funds, or the like. Typically, the user's account contains records of the resources owned by the user. Account data may be stored in an account database within the entity's systems.

Embodiments of the present disclosure provide a solution for on-boarding and continued support of non-conventional, or “supervised,” resource account users that own and maintain a resource account with an entity, or that may be authorized as an additional user on an existing user resource account stored with the entity. As used herein, the term “non-conventional” user refers to a certain user that may not previously have established a resource account, but may still benefit from limited interaction, gradually increased interaction, or supervised interaction with resource accounts. For instance, a non-conventional user may be a user who is below a certain experience level, has had less than a threshold amount of birthdays, or the like, whom is interested in learning effective methods of resource management and accounting principles, but does not yet have the ability to establish a credit history or independent resource account of their own. In other instances, the non-conventional user may be a user that has had a requisite number of birthdays to be considered a legal adult and can legally establish an independent account, but may still benefit from educational guidance with respect to responsible and effective management of resources, budgeting of resources, investing of resources or the like. It is understood that the terms non-conventional user and supervised user may be used interchangeably herein.

Additionally, the non-conventional user may, in some instances, benefit from the simulated or gradual introduction to channels of resource transfer, such as resource transaction channels (e.g. use of credit cards, checks, or the like), deposit channels (e.g. establishment of a savings account, accrual of interest, or the like), and withdrawal channels (e.g. use of an automated teller machine, or “ATM,” interaction with an entity agent or teller at an entity location, or the like). In some instances, the entity may build a relationship with the non-conventional user over time, and may establish a rapport or account history with the non-conventional user such that the entity may deem the non-conventional user as a low hazard candidate for a resource account by the time they reach the appropriate or requisite legal number of birthdays or years of life to establish an individual resource account or credit line of their own.

As such, the solution provides systems that are designed to both encourage and educate non-conventional users regarding resource management in a number of ways. Additionally, the solution described herein is designed to provide tools for users to manage, interact, and supervise non-conventional users, offering users, such as parents of non-conventional users, the ability to set preferences and easily access, protect, and manage information regarding one or more non-conventional users' activity and interaction with resource accounts, as well as their management and access to resources stored in such accounts.

In some embodiments, educational content may be provided through the use of simulated resource management exercises, establishment of goals and milestones, the provision of specialized resource channels for non-conventional users, or the like. In the same or similar embodiments, motivations may be provided in the form of goals and associated rewards, gamification of resource management practices, guaranteed earning of additional resources based on completed milestones, establishment of rewards with partnering entities related to non-conventional user interests, simplified or tailored user interface platforms provided on user devices, or the like. The system may further provide for automated execution of certain processes based set user preferences, and may provide proactive alerts, recommendations, and feedback based on activity of users and non-conventional users as they interact with resource accounts.

An exemplary use case of the system described herein follows. The system may be owned and/or operated by an entity such as a financial institution, where the resource account management platform aggregates data regarding an account of a user (e.g., a client of the financial institution). For example, the aggregated data may include account settings, user preferences, account resources (e.g., an account balance), history of interactions between the user and entity (e.g., account logins, software installed, locations of the entity visited by the user, or the like), products or services currently in use and/or offered by the entity, or the like. In such an embodiment, the system may comprise an account interface tool, where the account interface tool provides, via a graphical interface, one or more indicators (e.g., status meter, gauge, chart, graph, or the like) of various features the client may use that are offered by their resource account with the entity. For instance, the account interface tool may notify the user about which features are being used or not being used. If the system detects that a particular feature is not being used, the graphical interface may further provide an interactive link (e.g., clickable button, hyperlink, or the like) which may direct the client to a set-up page for the non-activated feature (e.g., savings goal-setting, controlled resource spending tools, educational games, access to credit lines, access to investment strategy recommendations and education, or the like). In this way, the system may allow the users to efficiently navigate the various features offered by the entity for account optimization purposes.

In some embodiments, the graphical interface may be configured to present to the user a guided setup page (e.g., a landing zone) which may present to the user a process flow for optimizing the user's account or for on-boarding a supervised user. For instance, the graphical interface may display various items to the user, such as an itemized list of steps that the user may take to enroll in the products and/or services offered by the entity, new products or features, or the like. In some embodiments, the graphical interface may further display legacy products or services provided by the entity which may still be in use by the client. The system may further display a comparison of the benefits and/or features of legacy products in comparison with newer products such that the client may at a glance determine which product is optimal.

In some embodiments, the system may be configured to integrate features and/or functions across multiple communication channels. In this regard, the system may automatically push information about certain features and/or the signup of said features or functions to the user device (e.g., a first communication channel) based on an interaction with the user across a second communication channel or device. In an exemplary embodiment, the entity may have had a telephone conversation with a client about a savings oriented educational feature of the entity geared toward helping young supervised users with understanding the management of resources. Based on the telephone conversation, the system may automatically push a signup page or process of on-boarding the savings oriented educational feature to the user via a user device (e.g., mobile phone).

In other embodiments, a decision engine and/or artificial intelligence (“AI”) system may automatically prioritize which features to highlight to the user based on their account information or information known about the user. In certain embodiments, the decisioning of the AI system may be overridden via an associate interaction. For instance, if the AI system has decided to prioritize informing the user about savings motivations for supervised users, but an agent (e.g., an employee of the entity) has determined that the user is not interested in that particular product (e.g., via a phone conversation with the client), the agent may override the notification regarding certain features with respect to said user. The system may further use machine learning to determine prioritizations on a per-user basis. For instance, the system may determine, via machine learning, that a particular user responds well to a particular prioritization, where a supervised user may respond well to a second prioritization.

The system may further be configured to recognize behaviors or patterns of the user (e.g., via machine learning). For instance, the system may detect that the user is having issues with a payment card (e.g., the user is repeatedly attempting to insert the card into a payment terminal or ATM). Based on detecting the user behavior and/or the underlying issue, the system may automatically push a notification to the user regarding the underlying issue (e.g., the security chip on the credit card has failed). In such an embodiment, the notification may recommend a solution to the underlying issue (e.g., recommend that the user replace the credit card). In other embodiments, the system may further track user's purchasing and/or payment behaviors, or track the behaviors of supervised users that are authorized to access the user's account or may be authorized on a case-by-case basis or in some limited manner to access resources from the user's account (e.g. the user may set preferences to authorize a child to use a debit card attached to the user's resource account in order to make certain types of purchases in a certain location, for specific types of goods or services, or during a specific time frame). Based on the user's behaviors and set preferences, the system may notify the user of activity on their account that has been authorized or denied based on the user's set preferences and behaviors. In some embodiments, the system may further learn the timing of behaviors of the user. For instance, if the system detects that the user typically accesses the entity system in the evening, the system may time pushing certain notifications to the user to coincide with the times in which the user is generally active in the entity system.

In some embodiments, the system may provide information to the user or supervised user via a mobile device, web browser, wearable device, IoT device, or the like in order to provide resource account summary information or to assist in the creation of goals and enrollment in certain motivations. For instance, the supervised user may enroll in an earning and savings program in which the resource account management tool is programmed by the user to record the supervised user's daily, weekly, or monthly allowance. In some embodiments, the resource account management tool may identify certain products, motivations and goals that the supervised user may feasibly achieve and work towards by allocating and saving resources over a period of time. For instance, the system may identify, based on the supervised user's number of birthdays, that they may be interested in a number of products that other others of that same number of birthdays are interested in, or that coincide with a portion of the supervised user's weekly allowance if the portion of the weekly allowance is saved for a given period of time, such as a month.

In some embodiments, the relationship of the supervising user and the supervised user may not be familial, but instead job or employment based. For instance, the supervising user may be a business manager who maintains and manages one or more accounts for supervised users (employees, staff members, or the like). In some embodiments, the goals or tasks shown in the resource account management tool may be related to job or employment milestones, tasks, assignments or the like which the supervised user may choose to complete in order to receive a motivation or reward, in the form of resources or the like.

In some embodiments, the system may interact with the supervised user, by displaying a graphical depiction of the products, price of the products, transmit an audio message or the like, and may partner such information with additional helpful contextual information such as current savings, savings goal, estimated period of time to reach the goal, or the like. For instance, the system may display the information on a smart home device that contains a graphical user interface in response to an audio request from the supervised user to retrieve such information. In some embodiments, the system may accompany the graphical depiction of the information with an audio response. The requested information may also include additional recommendations and links to directly purchase recommended products, services, or redeem rewards. Depending on the account authorization preferences associated with the resource account as set by the user, the purchasing of products may be executed directly, or in other embodiments may require further authorization from the user or user's parent. In some instances, the system may be programmed to forward the goal to the user or parent via a separate channel of communication, such as directly to the user's mobile device, wearable or the like, so that the user may be informed about the supervised user's goals, interests, and desired future purchases.

The system may also support user authentication via alternative credentials. For instance, rather than authenticating a user via a username and password (e.g., as used in online transactions), the system may support authentication of a user via a card associated with the user (e.g., a debit card of the user). In some embodiments, the system may further integrate various features, products, and/or services of partnered entities and/or affiliate entities.

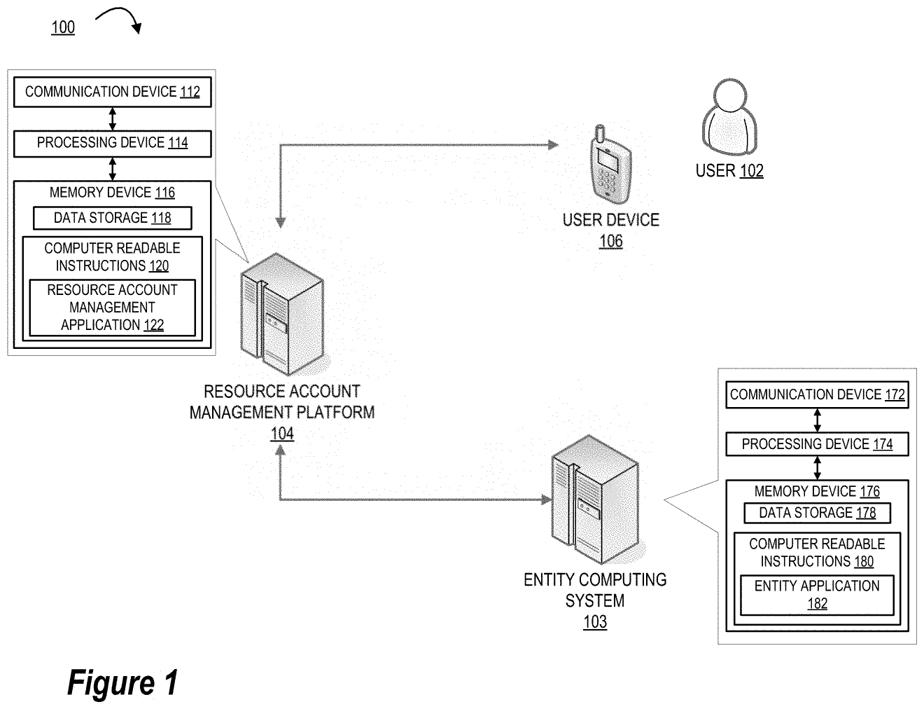

Turning now to the figures, FIG. 1 illustrates an operating environment for the supervised resource distribution account management platform, in accordance with one embodiment of the present disclosure. In particular, FIG. 1 illustrates a resource account management platform 104 that is operatively coupled, via a network, to a user device 106 and/or an entity computing system 103. In such a configuration, the resource account management platform 104 may transmit information to and receive information from the user device 106 and/or the entity computing system 103. It should be understood that FIG. 1 illustrates only an exemplary embodiment of the operating environment 100, and it will be appreciated that one or more functions of the systems, devices, or servers as depicted in FIG. 1 may be combined into a single system, device, or server. For instance, the functions of the resource account management platform 104 and the entity computing system 103 may be executed on a single computing system. Furthermore, a single system, device, or server as depicted in FIG. 1 may represent multiple systems, devices, or servers.

The network may be a system specific distributive network receiving and distributing specific network feeds and identifying specific network associated triggers. The network include one or more cellular radio towers, antennae, cell sites, base stations, telephone networks, cloud networks, radio access networks (RAN), WiFi networks, or the like. Additionally, the network may also include a global area network (GAN), such as the Internet, a wide area network (WAN), a local area network (LAN), or any other type of network or combination of networks. Accordingly, the network may provide for wireline, wireless, or a combination wireline and wireless communication between devices on the network.

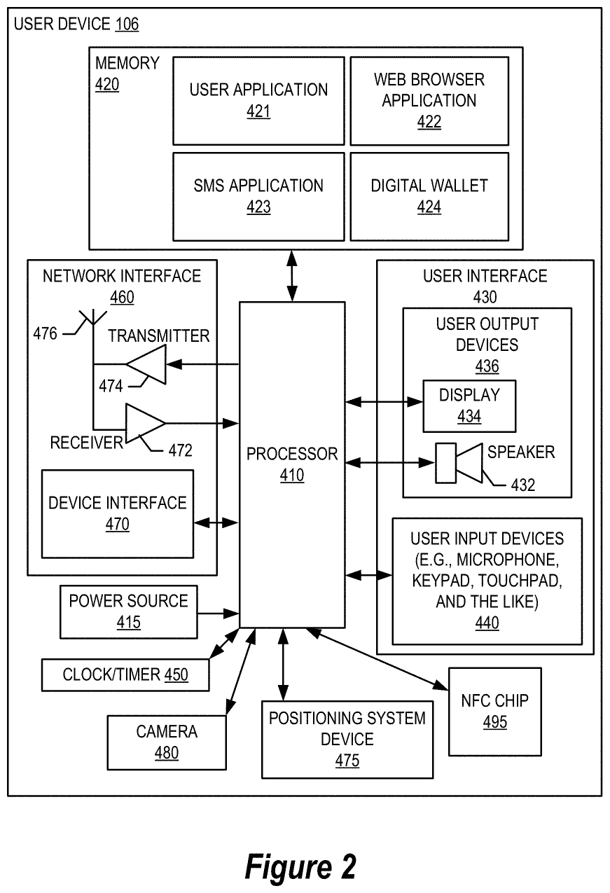

The user device 106 as depicted in FIG. 1, and as further described in FIG. 2, may be a device which is owned and/or operated by a user 102. The user 102 may use the user device 106 to log onto the resource account management platform 104 and/or the entity computing system 103 to access the data aggregation functions as described herein. In this regard, the user device 106 may be a mobile device such as a smartphone, wearable smart device, tablet, laptop computer, or the like. In other embodiments, the user device 106 may be a stationary device such as a desktop computer, IoT device, networked terminal, or the like.

As further illustrated in FIG. 1, the resource account management platform 104 may be a computing system within the entity system which provides data aggregation and integration functions across multiple channels. Accordingly, the resource account management platform 104 may comprise a communication device 112, a processing device 114, and a memory device 116, where the processing device 114 is operatively coupled to the communication device 112 and the memory device 116. The processing device 114 uses the communication device 112 to communicate with the network and other devices on the network, such as, but not limited to the user device 106 and/or the entity computing system 103. As such, the communication device 112 generally comprises a modem, antennae, WiFi or Ethernet adapter, radio transceiver, or other device for communicating with other devices on the network.

The memory device 116 comprises computer-readable instructions 120 and data storage 118, which in one embodiment includes the computer-readable instructions 120 of a resource account management application 122. The resource account management application 122 may comprise executable code for causing the processing device 114 to perform various data aggregation and integration functions with respect to data associated with the user 102. In this regard, the resource account management platform 104 may receive authentication credentials from the user 102, the user device 106, and/or the entity computing system 103 and authenticate/authorize users and applications based on the authentication credentials. Examples of said authentication credentials may include a username and password combination, PIN, secure token, cryptographic key, biometric data, or the like.

The operating environment 100 may further comprise an entity computing system 103. The entity computing system 103 may refer to a computing system which may be operated by a user such as an administrator or employee of the entity. The entity computing system 103 may comprise a processing device 174 operatively coupled to the communication device 172 and a memory device 176 comprising data storage 178 and computer readable instructions 180. The computer readable instructions 180 may comprise an entity application 182 which may be configured to instruct the processing device 174 to execute certain functions over the network, such as interacting with the user device 106 and/or the resource account management platform 104.

The communication device 172, and other communication devices as described herein, may comprise a wireless local area network (WLAN) such as WiFi based on the Institute of Electrical and Electronics Engineers' (IEEE) 802.11 standards, Bluetooth short-wavelength UHF radio waves in the ISM band from 2.4 to 2.485 GHz or other wireless access technology. Alternatively or in addition to the wireless interface, the entity computing system 103 may also include a communication interface device that may be connected by a hardwire connection to the resource distribution device.

The computing systems described herein may each further include a processing device communicably coupled to devices as a memory device, output devices, input devices, a network interface, a power source, a clock or other timer, a camera, a positioning system device, a gyroscopic device, one or more chips, or the like.

In some embodiments, the computing systems may access one or more databases or datastores (not shown) to search for and/or retrieve information related to the service provided by the entity. The computing systems may also access a memory and/or datastore local to the various computing systems within the operating environment 100.

The processing devices as described herein may include functionality to operate one or more software programs or applications, which may be stored in the memory device. For example, a processing device may be capable of operating a connectivity program, such as a web browser application. In this way, the computing systems may transmit and receive web content, such as, for example, product valuation, service agreements, location-based content, and/or other web page content, according to a Wireless Application Protocol (WAP), Hypertext Transfer Protocol (HTTP), and/or the like.

A processing device may also be capable of operating applications. The applications may be downloaded from a server and stored in the memory device of the computing systems. Alternatively, the applications may be pre-installed and stored in a memory in a chip.

The chip may include the necessary circuitry to provide integration within the devices depicted herein. Generally, the chip will include data storage which may include data associated with the service that the computing systems may be communicably associated therewith. The chip and/or data storage may be an integrated circuit, a microprocessor, a system-on-a-chip, a microcontroller, or the like. In this way, the chip may include data storage. Of note, it will be apparent to those skilled in the art that the chip functionality may be incorporated within other elements in the devices. For instance, the functionality of the chip may be incorporated within the memory device and/or the processing device. In a particular embodiment, the functionality of the chip is incorporated in an element within the devices. Still further, the chip functionality may be included in a removable storage device such as an SD card or the like.

A processing device may be configured to use the network interface to communicate with one or more other devices on a network. In this regard, the network interface may include an antenna operatively coupled to a transmitter and a receiver (together a “transceiver”). The processing device may be configured to provide signals to and receive signals from the transmitter and receiver, respectively. The signals may include signaling information in accordance with the air interface standard of the applicable cellular system of the wireless telephone network that may be part of the network. In this regard, the computing systems may be configured to operate with one or more air interface standards, communication protocols, modulation types, and access types. By way of illustration, the devices may be configured to operate in accordance with any of a number of first, second, third, fourth, and/or fifth-generation communication protocols and/or the like. For example, the computing systems may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with fifth-generation (5G) wireless communication protocols, or the like. The devices may also be configured to operate in accordance with non-cellular communication mechanisms, such as via a wireless local area network (WLAN) or other communication/data networks.

The network interface may also include an application interface in order to allow a user or service provider to execute some or all of the above-described processes. The application interface may have access to the hardware, e.g., the transceiver, and software previously described with respect to the network interface. Furthermore, the application interface may have the ability to connect to and communicate with an external data storage on a separate system within the network.

The devices, platforms, and computing systems depicted in FIG. 1 may have an interface that includes user output devices and/or input devices. The output devices may include a display (e.g., a liquid crystal display (LCD) or the like) and a speaker or other audio device, which are operatively coupled to the processing device. The input devices, which may allow the devices to receive data from a user 102, may include any of a number of devices allowing the devices to receive data from a user 102, such as a keypad, keyboard, touch-screen, touchpad, microphone, mouse, joystick, other pointer device, button, soft key, and/or other input device(s).

The devices, platforms, and computing systems may further include a power source. Generally, the power source is a device that supplies electrical energy to an electrical load. In some embodiment, power source may convert a form of energy such as solar energy, chemical energy, mechanical energy, or the like to electrical energy. Generally, the power source may be a battery, such as a lithium battery, a nickel-metal hydride battery, or the like, that is used for powering various circuits, e.g., the transceiver circuit, and other devices that are used to operate the devices. Alternatively, the power source may be a power adapter that can connect a power supply from a power outlet to the devices. In such embodiments, a power adapter may be classified as a power source “in” the devices.

As described above, the devices, platforms, and computing systems as shown in FIG. 1 may also include a memory device operatively coupled to the processing device. As used herein, “memory” may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like. The memory device may store any of a number of applications or programs which comprise computer-executable instructions/code executed by the processing device to implement the functions of the devices described herein. The computing systems may further comprise a gyroscopic device. The positioning system, input device, and the gyroscopic device may be used in correlation to identify phases within a service term.

Each computing system may also have a control system for controlling the physical operation of the device. The control system may comprise one or more sensors for detecting operating conditions of the various mechanical and electrical systems that comprise the computing systems or of the environment in which the computing systems are used. The sensors may communicate with the processing device to provide feedback to the operating systems of the device. The control system may also comprise metering devices for measuring performance characteristics of the computing systems. The control system may also comprise controllers such as programmable logic controllers (PLC), proportional integral derivative controllers (PID) or other machine controllers. The computing systems may also comprise various electrical, mechanical, hydraulic or other systems that perform various functions of the computing systems. These systems may comprise, for example, electrical circuits, motors, compressors, or any system that enables functioning of the computing systems.

FIG. 2 provides a block diagram illustrating the user device 106 of FIG. 1, in accordance with an embodiment of the invention. In one embodiment of the invention, the user device 106 is a mobile device. However, it should be understood that a mobile device or mobile telephone are merely illustrative of one type of user device 106 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned. In some embodiments, one or more of the functionalities or components of the user device 106 may be represented in whole or in part by one or more auxiliary devices 170.

Furthermore, it should be known that multiple computing device systems 400 may be owned by or accessed by the user 110 within the system environment 100 of FIG. 1, and these separate computing device systems 400 may be in network communication with each other and the other systems and devices of the system environment 100. For example, a first user device 106 may comprise a mobile phone of the user 110 that includes an NFC chip with resource data stored therein, and this mobile phone may be placed within an NFC interaction distance from an NFC reader device of a second user device 106 that comprises a personal computer of the user 110.

Some embodiments of the user device 106 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the user device 106. For example, the processor 410 may include a digital signal processor device, a microprocessor device, and various analog to digital converters, digital to analog converters, and/or other support circuits. Control and signal processing functions of the user device 106 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the user device 106 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of a wireless network. In this regard, the user device 106 may be configured to operate with one or more air interface standards, communication protocols, modulation types, and access types. By way of illustration, the user device 106 may be configured to operate in accordance with any of a number of first, second, third, and/or fourth-generation communication protocols and/or the like. For example, the user device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The user device 106 may also be configured to operate in accordance with non-cellular communication mechanisms, such as via a wireless local area network (WLAN) or other communication/data networks.

As described above, the user device 106 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the user device 106 to receive data from a user such as the user 110, may include any of a number of devices allowing the user device 106 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The user device 106 may also include a positioning system device 475 that is configured to be used by a positioning system to determine a location of the user device 106. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the user device 106. In other embodiments, the positioning system device 475 includes a proximity sensor or transmitter, such as an RFID tag, that can sense or be sensed by devices known to be located proximate a merchant or other location to determine that the user device 106 is located proximate these known devices.

The user device 106 further includes a power source 415, such as a battery, for powering various circuits and other devices that are used to operate the user device 106. Embodiments of the user device 106 may also include a clock or other timer 450 configured to determine and, in some cases, communicate actual or relative time to the processor 410 or one or more other devices.

The user device 106 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the user device 106 and/or one or more of the process/method steps described herein. For example, the memory 420 may include such applications as a conventional web browser application 422, or a user application 421, a digital wallet application 424, (or any other application provided by the managing entity system 200). These applications also typically instructions to a graphical user interface (GUI) on the display 430 that allows the user 110 to interact with the user device 106, the managing entity system 200, and/or other devices or systems. In one embodiment of the invention, when the user 110 decides to enroll in a user application 421 program, the user 110 downloads, is assigned, or otherwise obtains the user application 421 from the managing entity system 200, or from a distinct application server (e.g., from the resource account management platform 104). In other embodiments of the invention, the user 110 interacts with the managing entity system 200 or the resource account management platform 104 via the web browser application 422 in addition to, or instead of, the user application 421. The same mechanisms may be put in place to install, store, or otherwise access the digital wallet application 424. The memory 420 of the user device 106 may comprise a Short Message Service (SMS) application 423 configured to send, receive, and store data, information, communications, alerts, or the like via a wireless telephone network.

The user application 421 may comprise an application stored in the memory 420 that is configured to control and/or communicate with a digital wallet 424 of the mobile device system 400 to receive and store resource information or resource account information (e.g., account balances, resource amounts, resource types, wallet addresses public keys, private keys, or the like) from other devices described herein. The user application 421 may also be configured to communicate information received from the digital wallet application 424, the web browser application 422, and/or the SMS application 423. In some embodiments, the user application 421 may be configured to receive instructions from a separate system and cause one or more components of the user device 106 to perform one or more actions. For example, the user application 421 may be configured to receive instructions for erasing certain information from an intelligent resource instrument and writing new information on that instrument. The user application 421 may then cause the near field communication (NFC) chip 495 to erase the certain information from an intelligent resource instrument that is within an interaction distance of the NFC chip 495 and then write the new information onto the intelligent resource instrument.

The digital wallet 424 of the user device 106 may comprise an application created by and/or managed by a financial institution that is configured to securely store financial information, resource account information, user configuration information, billing information, shipping information, authentication information, dynamic resource value information (e.g., dynamic card image or video information), or the like. The digital wallet 424 may be configured to receive account or card information (e.g., credit card information, account information, currency information, blockchain information, or the like) from that has been extracted from an intelligent resource instrument or one or more systems and automatically populate fields within the digital wallet application 424 with the extracted information. For example, the extracted information may be formatted such that the information type and the information field is known and by the digital wallet 424 and can therefore be matched to an applicable field of the digital wallet 424.

The digital wallet 424 may additionally be configured to initiate or otherwise communicate information as part of a transaction request. For example, the user 110 may use the user device 106 to initiate a transaction by tapping or otherwise positioning the NFC chip 495 of the user device 106 within an interaction distance from a point of sale device comprising an card reader device (e.g., the card reader device system 130). This interaction may prompt the digital wallet application 424 to provide transaction information (e.g., credit card information, user name, billing information, wallet address, transaction identification information, authorization information, blockchain information, private key, public key, or the like), and the digital wallet application 424 may then transmit the transaction information to the point of sale device for the purpose of conducting and/or authenticating the requested transaction.

The memory 420 can also store any of a number of pieces of information, and data, used by the user device 106 and the applications and devices that make up the user device 106 or are in communication with the user device 106 to implement the functions of the user device 106 and/or the other systems described herein. For example, the memory 420 may include such data as transaction history data, positional data of the user device 106, or the like.

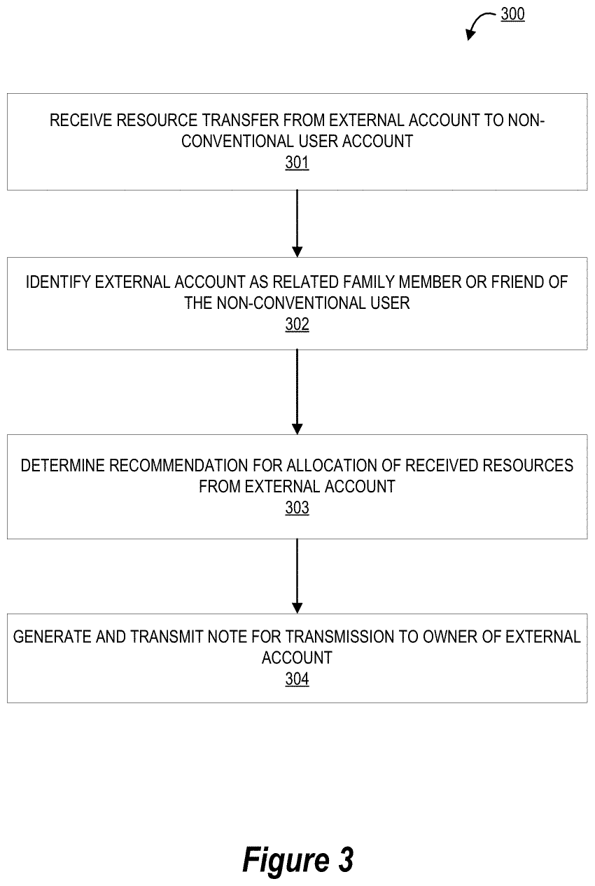

FIG. 3 illustrates a process flow 300 for a resource transfer acceptance and response process, in accordance with one embodiment of the present disclosure. In some embodiments, a supervising user, such as a parent, may be interested in creating a resource account for a supervised user. Depending on the number of years of life of the supervised user, the supervising user's preferences with regard to the supervised user's autonomy in managing resources, or the like, the system may intelligently recommend certain services and educational modules to effectively on-board the supervised user with a newly created resource account that is linked to and at least partially managed by the supervising user's account. The system may receive a request from the supervising user to create a supervised user resource account, otherwise referred to as “onboarding” the supervised user to the resource management platform. The system then initiates the creation of the supervised user resource account by communicating, via a user interface on a user device, a series of questions and preference options to gain a more detailed description of the supervised user.

Depending on the supervised user's number of years of life, the supervised user may be eligible for a range of autonomy with regard to how the account is managed. For instance, a certain user group under 11 years of life may only be able to view their resource account, while a user group in the range of 12-17 years of life may be eligible to access resources, transfer resources, and spend resources on their own. It is understood that these ranges may vary, and are provided only as examples that the delineation between user permissions may be altered based on the years of life of the supervised user. It is understood that the level of autonomy based on years of life of the supervised user may differ based on settings programmed by the supervising user, may be influenced by the law in a particular geographic area or jurisdiction, or both, and that the system may be intelligently designed to identify these restrictions and present them to the supervising user accordingly as suggestions or requirements depending on the scenario. In some embodiments, the system may crowd-source anonymized data regarding the management of supervised user accounts and provide peer insights on the level of interaction typically allowed for certain groups of supervised users, and potential benefits of introducing certain concepts at given milestones, again enhancing the ability for the supervising user to utilize the system to capitalize on potential educational opportunities.

The system may guide the supervising user in the creation of the supervised user's resource account, providing a tutorial to both the supervising and supervised user (e.g., the tutorial may differ in language and complexity for the supervised user and the supervising user) with regard to how the supervised user's resource account will operate and may be managed. The tutorial provided may be bifurcated such that the supervising user receives a more complex and detailed description of user preferences, permissions, and account management principles, while the supervised user simply receives an introduction to resource accounts, and their permitted activities and interactions with the account in general. The system may onboard the supervised user by creating and linking the supervised user's resource account with a resource account of the supervised user, such that the accounts may interface with one another and provide the other services and features described throughout the present disclosure.

In some embodiments, the supervised user's resource account may be transitioned as the supervised user grows older, such that the account is automatically converted or upgraded over time as the user reaches a new bracket in terms of years of life. For instance, a supervised user that has been on-boarded at 8 years of life may receive additional permissions at 11 years, and again at 18 years, at which point the user may be given the option to de-link their account from the supervising user's account management and maintain full control over their available resources and spending habits.

In some embodiments, the supervised user may be issued a payment instrument associated with their resource account, such as their own personal debit card. While the supervised user's debit card may appear to be a fully operational and conventional debit card, it may have certain restrictions placed on it by the supervising user as dictated in the supervising user's preferences and permissions set from the resource management platform. For instance, the supervised user's debit card may be associated with a pin code that only works at certain times of day, or at certain locations in order to authorize payment. In other embodiments, the supervised user's debit card may only be operational with ATM locations owned by the issuing entity, and may only provide access to certain denominations of resources per period of time. For instance, the supervised user may only be able to withdraw increments of five or ten dollars at a time. In other embodiments, the supervising user may set a withdrawal limit, geofence limit for authorized spending, limited spending categories, or one-time use authorizations to use the payment instrument at a certain time or place. As the supervised user grows older, the ability for the supervising user to place restrictions on the supervised user's payment instrument may decrease, or be deactivated completely if the supervised user reaches adulthood.

As shown, the process in FIG. 3 begins whereby a supervised user receives a resource transfer to their resource account from some external resource account, depicted in block 301. In block 302, the process identifies the external account as being owned by a relative, friend, or other known individual. The system may determine a recommendation for allocation of the received resources, as shown in block 303, such as recommending that the supervised user transfer the resources to the user's savings account, checking account, investment fund, or the like, or use it toward an existing financial goal, such as a purchase. Once the user has chosen a way to allocate the received resources, the system may then generate a “thank-you” note to the external account individual from the user, at which point the user may elect to transmit the thank-you note to the individual, as shown in block 304.

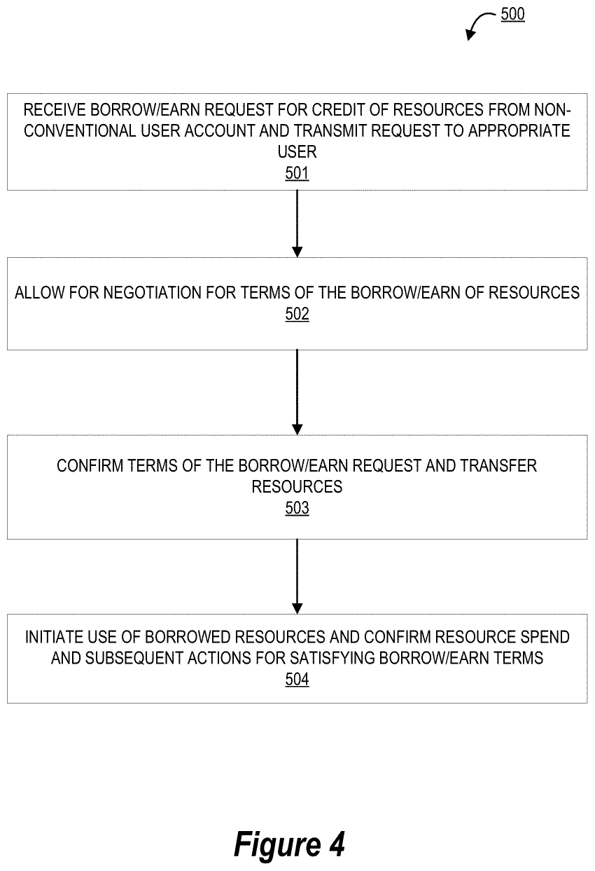

FIG. 4 illustrates a process flow 500 for initiation and management of a borrowed resource transfer between supervised and supervising user resource accounts, in accordance with one embodiment of the present disclosure. In some embodiments, the supervised user may require additional resources in order to fund a purchase or reach a goal in the short-term, and may want to borrow resources from a parent, sibling, friend, other supervising user, or the like. The system may receive a request from the supervised user to initiate a borrow or earn request from another user, as shown in block 501, and will transmit the request to the appropriate supervising user. As shown in block 502, the system may allow the users to bargain or negotiate the terms of the borrow or earn request. For instance, the supervising user that is providing the borrowed resources may offer to provide the resources if the supervised user pays the resources back with interest over time, completes a certain task, pays the resources back within a certain time frame, or spends the resources in a specific manner, or the like. Once the users have decided on agreeable terms to the borrow or earn request, the system may then confirm and record the terms of the borrow or earn request and transfer the selected amount of resources from the supervising user's account to the supervised user's account, as shown in block 503. Finally, as shown in block 504, the system may monitor the use of the resources to confirm how the resources were allocated or spent, and may subsequently confirm when the supervised user completes the terms of the agreement reached with regard to block 502. For instance, the supervised user may confirm the completion of a task in a similar manner as described in FIG. 2 by providing proof of completion via uploaded photo, message, or interaction with a connected smart device.

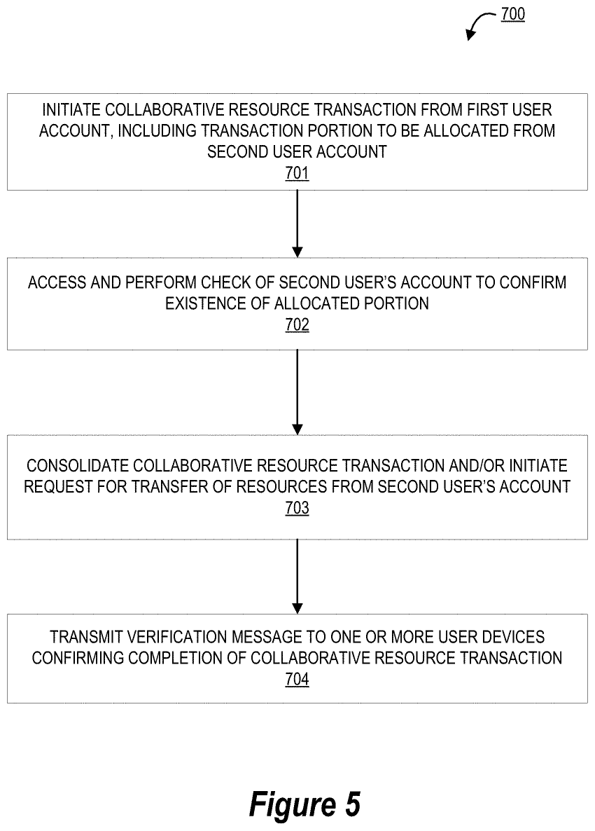

FIG. 5 illustrates a process flow 700 for initiation execution of a collaborative resource transaction, in accordance with one embodiment of the present disclosure. As shown in block 701, the process begins whereby a collaborative transaction is initiated involving more than one resource account. In exemplary embodiments of process 700, one of the accounts would belong to a supervising user, such as a parent, or the like, and the supervised user resource account may belong to a supervised user, such as the supervising user's child or other party which owns a supervised resource account. For instance, the first and supervised user may be at a merchant location where the supervised user is interested in making a purchase, but does not have the necessary funds or resource payment instrument on hand to access their resource account and complete the transaction. In this instance, the supervising user may offer to “spot” the supervised user for the transaction, effectively loaning the supervised user an amount of resources to cover the transaction from their account while initiating a collaborative transaction wherein resources are transferred from supervising user to merchant and from supervised user to supervising user simultaneously, or within a short time frame.

As shown in block 702, the system performs a check of the resource amount in the supervised user's account, or the supervised user's account, in order to determine if the second use's account has necessary funds to cover the transaction. In some embodiments, the supervising user may be displayed with a message or alert indicating whether or not the supervised user's resource account has the necessary amount of funds for the transaction. In this instance, the supervising user may choose to move forward with the transaction and pay for the remaining necessary balance to complete the transaction, or may decline to move forward with the transaction. In either case where the supervising user chooses to move forward with the transaction (i.e. the supervised user has the necessary funds, or the supervising user is willing to cover the balance), the system may consolidate the transactions into a collaborative series of resource transfers wherein an amount of resources are transferred from the second use's account to the supervising user's account in order to cover all or part of the transaction value, as shown in block 703. At this point, resources may also be transferred from the supervising user's account to the merchant in order to complete the transaction. At the conclusion of the process 700, shown in block 704, a verification message may be generated and forwarded to one or more user devices of the first and/or supervised user summarizing the transaction value and successful completion of the collaborative payment. Depending on the resource amount transferred or programmed response to the completed collaborative transaction, the system may also generate information for the parent or supervising user that includes talking points for follow up communication about the completed transaction or terms of the agreement. For instance, if the supervising user receives an amount of resources that allows that user to reach a certain spending goal, the system may recognize this and prompt the parent of the user with talking points about responsible spending habits, borrowing terms, simple interest calculations for loans, avenues for investment and savings, and the like that may affect the child's decision to make a certain purchase, may allow them to make a more informed decision, or may allow the parent to capitalize on an opportunity for an educational financial discussion.

In some embodiments, the supervised user may be issued a survey or series of questions in order to determine if the supervised user was satisfied with the transaction in hindsight, which may be a helpful lesson for the supervised user to learn with respect to impulse purchases. If the supervised user indicates that they are subsequently experiencing regret regarding the particular transaction, the supervising user may receive an alert indicating this determination, and may also be presented with helpful recommendations or topics of conversation for the supervising user to have with the supervised user in order to further educate the supervised user on healthy spending habits.

Each communication interface described herein generally includes hardware, and, in some instances, software, that enables the computer system, to transport, send, receive, and/or otherwise communicate information to and/or from the communication interface of one or more other systems on the network. For example, the communication interface of the user input system may include a wireless transceiver, modem, server, electrical connection, and/or other electronic device that operatively connects the user input system to another system. The wireless transceiver may include a radio circuit to enable wireless transmission and reception of information.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, or the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, or the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for intelligent on-boarding and resource account management, the system comprising:
at least one memory device with computer-readable program code stored thereon;
at least one communication device;
at least one processing device operatively coupled to the at least one memory device and the at least one communication device, wherein executing the computer-readable program code is configured to cause the at least one processing device to:
receive, from a user device, a request to access the resource account management platform;
display to a user, via a graphical interface of the resource account management platform, a resource account summary and resource account management selections, wherein the resource account management selections comprise an option to onboard a second user;
receive a selection to onboard the second user to the resource account management platform;
onboard the second user by automatically creating a resource account for the second user and linking the resource account for the second user with a resource account of the user by authorizing resource transfers from the resource account of the user and the resource account of the second user; and
automatically link the resource account for the second user with one or more related user resource accounts.

2. The system of claim 1, wherein the one or more related user resource accounts further comprise existing resource accounts on the resource account management platform belonging to relatives, friends, or peers of the second user.

3. The system of claim 1, further comprising:
completing a resource transfer to the resource account of the second user;
identifying an originating account of the resource transfer as one of the one or more related user resource accounts;
determining a recommendation for allocation of the resource transfer; and
transmitting the recommendation for allocation of the resource transfer to the second user via the graphical user interface.

4. The system of claim 3, further comprising generating a template message to the owner of the originating account from the second user, wherein the template message includes a reference to the recommendation for allocation of the resource transfer.

5. The system of claim 1, further comprising:
receiving a request from the second user to initiate a borrow request, wherein the borrow request comprises borrowing a resource amount from the user;
transmitting the borrow request to the user via the graphical user interface of the resource account management platform;
providing options via the graphical user interface for the user to set negotiation terms for the borrow request, wherein the negotiation terms include a payback period, an optional interest rate, or required task; and
transmitting the negotiation terms to the second user via the graphical user interface.

6. The system of claim 1, further comprising:
receiving a request from the second user to initiate a collaborative transaction request, wherein the collaborative transaction comprises combining resources from the resource account of the user and the resource account of the second user;
transmitting the collaborative transaction request to the user via the graphical user interface of the resource account management platform;
providing options via the graphical user interface for the user to accept the collaborative transaction request; and
executing the collaborative transaction using resources from the resource account of the user and the resource account of the second user.

7. A computer program product for intelligent on-boarding and resource account management, the computer program product comprising a non-transitory computer-readable storage medium having computer-executable instructions to:
receive, from a user device, a request to access the resource account management platform;
display to a user, via a graphical interface of the resource account management platform, a resource account summary and resource account management selections, wherein the resource account management selections comprise an option to onboard a second user;
receive a selection to onboard the second user to the resource account management platform;
onboard the second user by automatically creating a resource account for the second user and linking the resource account for the second user with a resource account of the user by authorizing resource transfers from the resource account of the user and the resource account of the second user; and
automatically link the resource account for the second user with one or more related user resource accounts.

8. The computer program product of claim 7, wherein the one or more related user resource accounts further comprise existing resource accounts on the resource account management platform belonging to relatives, friends, or peers of the second user.

9. The computer program product of claim 7, further comprising:
completing a resource transfer to the resource account of the second user;
identifying an originating account of the resource transfer as one of the one or more related user resource accounts;
determining a recommendation for allocation of the resource transfer; and
transmitting the recommendation for allocation of the resource transfer to the second user via the graphical user interface.

10. The computer program product of claim 9, further comprising generating a template message to the owner of the originating account from the second user, wherein the template message includes a reference to the recommendation for allocation of the resource transfer.

11. The computer program product of claim 7, further comprising:
receiving a request from the second user to initiate a borrow request, wherein the borrow request comprises borrowing a resource amount from the user;
transmitting the borrow request to the user via the graphical user interface of the resource account management platform;
providing options via the graphical user interface for the user to set negotiation terms for the borrow request, wherein the negotiation terms include a payback period, an optional interest rate, or required task; and
transmitting the negotiation terms to the second user via the graphical user interface.

13. The computer program product of claim 7, further comprising:
receiving a request from the second user to initiate a collaborative transaction request, wherein the collaborative transaction comprises combining resources from the resource account of the user and the resource account of the second user;
transmitting the collaborative transaction request to the user via the graphical user interface of the resource account management platform;
providing options via the graphical user interface for the user to accept the collaborative transaction request; and
executing the collaborative transaction using resources from the resource account of the user and the resource account of the second user.

14. A computer implemented method for intelligent on-boarding and resource account management, the computer implemented method comprising:
receiving, from a user device, a request to access the resource account management platform;
displaying to a user, via a graphical interface of the resource account management platform, a resource account summary and resource account management selections, wherein the resource account management selections comprise an option to onboard a second user;
receiving a selection to onboard the second user to the resource account management platform;
onboarding the second user by automatically creating a resource account for the second user and linking the resource account for the second user with a resource account of the user by authorizing resource transfers from the resource account of the user and the resource account of the second user; and
automatically linking the resource account for the second user with one or more related user resource accounts.

15. The computer implemented method of claim 14, wherein the one or more related user resource accounts further comprise existing resource accounts on the resource account management platform belonging to relatives, friends, or peers of the second user.

16. The computer implemented method of claim 14, further comprising:
completing a resource transfer to the resource account of the second user;
identifying an originating account of the resource transfer as one of the one or more related user resource accounts;
determining a recommendation for allocation of the resource transfer; and
transmitting the recommendation for allocation of the resource transfer to the second user via the graphical user interface.

17. The computer implemented method of claim 16, further comprising generating a template message to the owner of the originating account from the second user, wherein the template message includes a reference to the recommendation for allocation of the resource transfer.

18. The computer implemented method of claim 14, further comprising:
receiving a request from the second user to initiate a borrow request, wherein the borrow request comprises borrowing a resource amount from the user;
transmit the borrow request to the user via the graphical user interface of the resource account management platform
provide options via the graphical user interface for the user to set negotiation terms for the borrow request, wherein the negotiation terms include a payback period, an optional interest rate, or required task; and
transmit the negotiation terms to the second user via the graphical user interface.

19. The computer implemented method of claim 14, further comprising:
receiving a request from the second user to initiate a collaborative transaction request, wherein the collaborative transaction comprises combining resources from the resource account of the user and the resource account of the second user;
transmitting the collaborative transaction request to the user via the graphical user interface of the resource account management platform;
providing options via the graphical user interface for the user to accept the collaborative transaction request; and
executing the collaborative transaction using resources from the resource account of the user and the resource account of the second user.

20. The computer implemented method of claim 19, further comprising transmitting a follow-up message to the user after the collaborative transaction, wherein the follow-up message comprises educational talking point recommendations for discussion with the second user.
